(19) United States
(12) Patent Application Publication
(10) Pub. No.: US 2009/0182807 A1
(43) Pub. Date: Jul. 16, 2009

(54) TERMINAL DEVICE, NETWORK SYSTEM, METHOD TO PROVIDE CONTEXT INFORMATION, AND PROGRAM TO PROVIDE CONTEXT INFORMATION

(75) Inventor: Jumpei Yamamoto, Tokyo (JP)

Correspondence Address: MORRISON & FOERSTER LLP, 425 MARKET STREET, SAN FRANCISCO, CA, 94105-2482, US

(73) Assignee: Access Co., Ltd., Chiyoda-ku, Tokyo (JP)

(21) Appl. No.: 12/300,635

(22) PCT Filed: Apr. 26, 2007
(86) PCT No.: PCT/JP2007/059035

§ 371 Date: Jan. 14, 2009

(30) Foreign Application Priority Data
May 12, 2006 (JP) 2006-133441

(51) Int. Cl. G06F 15/16; G06Q 30/00

(52) U.S. Cl. 709/203; 709/219; 705/34; 709/224; 709/238

(57) ABSTRACT

A terminal device is provided with a context information storing means for storing context information on a prescribed memory medium, a Cookie receiving means for receiving a Cookie to request specific context information in the case of communication with an outside server, a context information extracting means for extracting the specific context information from the prescribed memory medium in accordance with the received Cookie, and a transmitting means for transmitting the extracted context information to the outside server.

### FIELD OF THE INVENTION

The present invention relates to a terminal device, capable of communicating with an external server with use of cookies, and a network system having the terminal device. Further, the present invention relates to a method to provide context information, stored in the terminal device, to an external server through a given network and a program to provide the context information.

### BACKGROUND OF THE ART

Recently, it has been attempted to organize infrastructure for ubiquitous environment, in which one can access a communication network such as the internet regardless of his location. Various terminal devices to be used in the ubiquitous environment are expected. Such terminal devices include not only fixed terminals and mobile terminals (e.g., PDAs (Personal Digital Assistants) and mobile phones) but also home electric appliances such as refrigerators and microwave-ovens. Further, machines such as automobiles and automatic vending machines can be included.

In order to establish a role in the ubiquitous environment, a network system to process, for example, context information is disclosed in Japanese Patent Provisional Publication No. 2006-12076. According to the network system disclosed in the Japanese Patent Provisional Publication No. 2006-12076, context information stored in a terminal device can be collected so that a dynamic service and information can be provided to a user according to the user's request. More specifically, according to the Japanese Patent Provisional Publication No. 2006-12076, context information such as a current location of the user is transmitted to a server at a predetermined interval or according to the user's behavior. The server receiving the context information can provide a service or information to the user according to the user's request.

### DISCLOSURE OF THE INVENTION

As has been described above, in the network system disclosed in the Japanese Patent Provisional Publication No. 2006-12076, the context information is transmitted at a predetermined interval or according to the user's behavior. That is to say, the context information is transmitted when an event occurs in the terminal device. A destination of the transmitted context information is a predetermined server (hereinafter referred to as a specific server). Therefore, in the network system disclosed in the Japanese Patent Provisional Publication No. 2006-12076, servers other than the specific server cannot directly obtain the context information from the user. If the other servers wish to obtain the context information, the context information is provided from the specific server.

Additionally, in the network system disclosed in the Japanese Patent Provisional Publication No. 2006-12076, a type of the context information to be collected is decided by the specific server. In another aspect, in the network system, the other servers cannot decide a type of the context information to request by themselves.

However, as disclosed in the Japanese Patent Provisional Publication No. 2006-12076, the available context information to be collected ranges widely in various types. In addition, users' requirements change with times, and the context information to be requested change accordingly. Therefore, a network system in which each server can select a type of context information to request has been eagerly desired.

Therefore, in consideration of the above circumstances, the present invention aims to provide a network system, in which each server can flexibly and desirably set the type of the context information to be obtained from a terminal device, and a terminal device to desirably establish the network system. Further, the present invention also aims to provide a method and a program to provide the context information which enables each server to flexibly set the type of the context information to be obtained from the terminal device.

In order to solve the above problem, a terminal device according to an aspect of the present invention is capable of communicating with an external server. The terminal is characterized in having a context information storing system to store context information in a predetermined memory medium, a cookie receiving system to receive a cookie, which is to request for specific context information, during communication with the external server, a context information extracting system to extract the specific context information from the predetermined memory medium according to the received cookie, and a transmitting system to transmit the extracted context information to the external server.

According to the above configuration, a type of the context information to be provided to the external server is determined based on the cookie from the external server. Thus, by using the cookie, the terminal which can provide the context information required by the external server is achieved.

Further, a terminal according to another aspect of the present invention to solve the above problem includes at least one application capable of generating information which is to be context information, and capable of communicating with an external server. The terminal is characterized in having a cookie receiving system to receive a cookie, which is to request for specific context information, during communication with the external server, a context information obtaining system to operate the at least one application based on the received cookie and obtain context information being generated as a result of the operation, and a transmitting system to transmit the obtained context information to the external server.

Further, according to another aspect of the present invention to solve the above problem, a terminal capable of communicating with an external server is characterized in having a context information storing system to store context information in a predetermined memory medium, a data synchronization system to synchronize data in the predetermined memory medium and data in an external memory medium which is installed externally to the terminal by using a predetermined protocol, a cookie receiving system to receive a cookie to request for an address of the external memory medium during communication with the external server, and a transmitting system to transmit the address of the external memory medium to the external server based on the received cookie.

Further, a network system according to another aspect of the present invention to solve the above problem includes at least one of the above terminal and at least one external server which is capable of communicating with the terminal through a predetermined network. In the network system, the external server is characterized in having a cookie transfer system to pass a cookie to request for specific context information to the terminal which communicates with the external server itself, a page creating system to create a page based on the specific context information when the server receives the specific context information from the terminal which was operated in response to the cookie, and a page transmitting system to transmit the created page to the terminal.

Further, a network system according to another aspect of the present invention to solve the above problem includes at least one of the above terminal, at least one external server which is capable of communicating with the terminal through a network, and a synchronization server having an external memory medium of which data is synchronized with data in the predetermined memory medium of the terminal. In the network system, the external server includes a cookie transfer system to pass a cookie to request for specific context information to the terminal which communicates with the external server itself, and a context information requesting system to request the synchronization server for specific context information which is included in the external memory medium when the server receives an address of the external memory medium from the terminal which was operated in response to the cookie. The synchronization server obtains the specific context information from the external memory medium according to the request when the request from the external server is received to transmit to the external server. The external server further includes a page creating system to create a page based on the specific context information when the server receives the specific context information from the synchronization server, and a page transmitting system to transmit the created page to the terminal.

Further, a network system according to another aspect of the present invention to solve the above problem includes a plurality of terminals being interconnected within a predetermined LAN, and at least one of the terminals is capable of communicating with an external server through the Internet. In the network system, the at least one of the terminals includes a cookie receiving system to receive a cookie to request for specific context information during communication with the external server, and an instruction system to instruct the other terminals connected through the LAN based on the received cookie to pass the context information. Each of the other terminals includes a context information extracting system to extract the specific context information according to the instruction from the instruction system, and a transmitting system to transmit the extracted context information to the terminal being an issuer of the instruction. The at least one terminal receives to collect the context information transmitted from the other terminals and transmit the collected context information to the external server.

Further, a method according to another aspect of the present invention to solve the above problem is to provide context information contained in a terminal to an external server through a predetermined network. The method to provide context information includes a cookie receiving step, in which the terminal receives a cookie to request for specific context information transmitted from the external server, a context information extracting step, in which the specific context information is extracted by the terminal based on the cookie, and a first transmission step, in which the extracted context information is transmitted to the external server.

Further, a program according to another aspect of the present invention to solve the above problem is to provide context information, whereby a computer activates the method to provide context information.

### BRIEF DESCRIPTION OF ACCOMPANYING DRAWINGS

FIG. 1 A diagram to illustrate a network system according to an embodiment of the present invention.

FIG. 2 A block diagram to illustrate a configuration of a mobile terminal according to the embodiment of the present invention.

FIG. 3 A block diagram to illustrate functions of a browser engine included in a browser according to the embodiment of the present invention.

FIG. 4 A flowchart to illustrate processes to be executed in the network system according to a first embodiment of the present invention.

FIG. 5 A flowchart to illustrate processes to be executed in the network system according to a second embodiment of the present invention.

FIG. 6 A flowchart to illustrate processes to be executed in the network system according to a third embodiment of the present invention.

FIG. 7 A diagram to schematically illustrate a configuration of the network system according to a fourth embodiment of the present invention.

FIG. 8 A flowchart to illustrate processes to be executed in the network system according to the fourth embodiment of the present invention.

FIG. 9 A diagram to schematically illustrate a configuration of the network system according to an embodiment of POST.

FIG. 10 A diagram to schematically illustrate a configuration of the network system according to an embodiment of a home network.

FIG. 11 A diagram to hierarchically illustrate data stored in a flash memory of a mobile terminal according to another aspect of the present invention.

### DETAILED DESCRIPTION OF PREFERRED EMBODIMENTS

Hereinafter, embodiments of the present embodiment will be described with reference to the drawings.

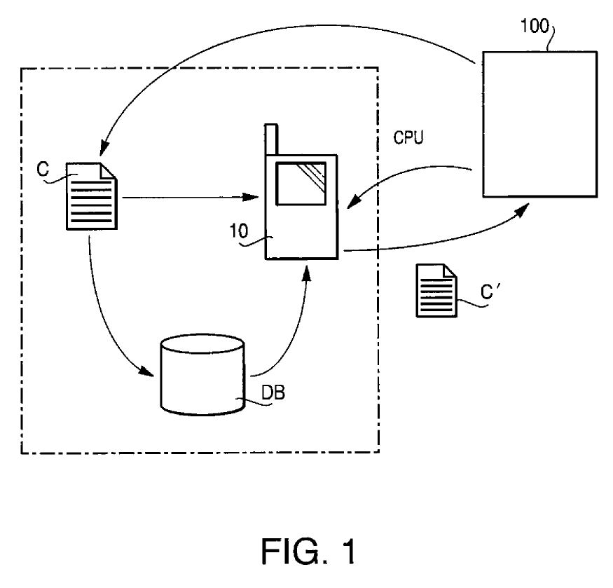

FIG. 1 is a diagram to illustrate the network system according to an embodiment of the present invention. As shown in FIG. 1, the network system according to the present embodiment is configured with a mobile terminal 10 and a server 100. The mobile terminal 10 receives a cookie C transmitted from the server 100 to store and searches through a DB (e.g., a flash memory 20, which will be described later) in the mobile terminal 10 based on contents of the cookie C (i.e., a request of the server 100). Next, information found by the search is appended to the cookie C to create a cookie C′, and the created cookie C′ is returned to the server 100. The server 100 dynamically creates a page based on the information appended to the cookie C′ and provide the created page to the mobile terminal 10. The above describes schematic behaviors of the network system of the present embodiment. Hereinafter, the network system of the present embodiment will be described in detail.

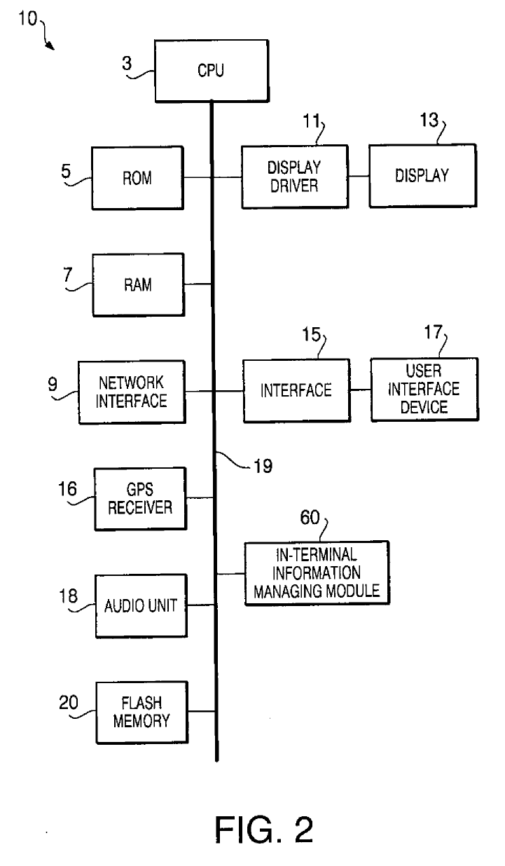

FIG. 2 is a block diagram to illustrate a configuration of the mobile terminal 10 according to the embodiment of the present invention. The mobile terminal 10 according to the present embodiment can be, for example, a mobile phone, a PHS (Personal Handy-phone System), and one of various mobile terminals such as a PDA.

As shown in FIG. 2, the mobile terminal 10 is provided with a CPU 3 to control the entire behaviors of the mobile terminal 10. The CPU 3 is connected with each component through a bus 19. The components include a ROM (Read-Only Memory) 5, a RAM (Random-Access Memory) 7, a network interface 9, a display driver 11, an interface 15, a GPS (Global Positioning System) receiver 16, an audio unit 18, and a flash memory 20. The display driver 11 and the interface 15 are respectively connected with a display 13, and a user interface device 17.

Various programs and various data are stored in the ROM 5 and the flash memory 20. Such programs stored in the ROM 5 include, for example, a browser 50. The browser 50 is an information browser software program to browse information described in a predetermined markup language stored online or offline. The flash memory 20 stores therein, for example, music data which will be described later.

The RAM 7 is an area in which the various programs stored in, for example, the ROM 5 are developed. When a user inputs a predetermined operation through the user interface device 17, the program stored in the ROM 5 (e.g., the browser 50) is read and developed in a predetermined area in the RAM 7 to be executed. Accordingly, the browser 50 is activated.

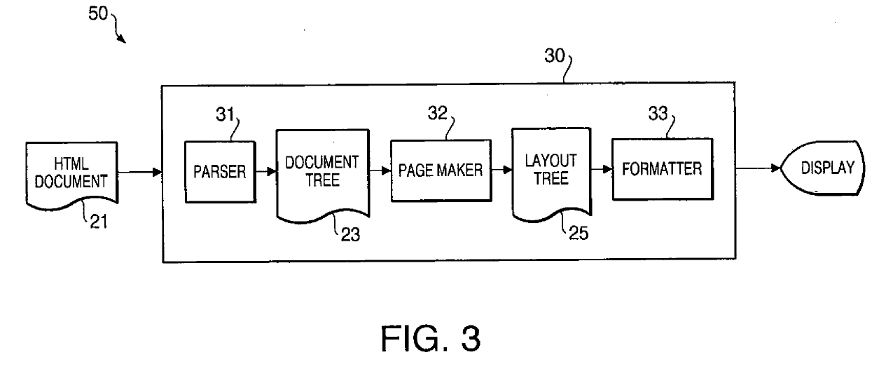

Next, functions of the browser 50 will be described. A browser engine 30, which is a fundamental component in the browser 50 will be described with reference to FIG. 3.

FIG. 3 is a block diagram to illustrate functions of the browser engine 30 in the browser 50 according to the embodiment of the present invention. As shown in FIG. 3, the browser engine 30 includes functional blocks of a parser 31, a page maker 32, and a formatter 33.

When the user inputs a URI (Uniform Resource Identifier) through the user interface device 17 or selects one of anchor tags to enter the URI in a page displayed in the display 13, the browser 50 behaves to obtain an html document 21 (i.e., a requested page) from the URI (i.e., the server) on the internet. The obtained html document 21 is passed to the parser 31.

The “page” is a piece of data to be obtained from the server through the network by a client (i.e., the browser 50 in the present embodiment) and refers to entire contents to be displayed when a URI is designated by the user. A page is configured with various data including, for example, an html document, an image file, and audio data.

The parser 31 renders the html document 21 obtained from the internet through the network interface 9 and creates a document tree 23, in which a grammatical structure of the html document 21 is represented in a tree structure. It is to be noted that the document tree 23 merely represents the grammatical structure of the html document 21 and excludes information concerning presentation of the document.

Next, the page maker 32 creates a layout tree 25, which include a representing format of the html document 21 such as blocks, inline, tables, lists, and items. That is to say, the layout tree 25 includes information concerning orders of the blocks, inline, and tables. It is to be noted that the layout tree 25 does not include information concerning locations and sizes of the elements (i.e., blocks, inline, tables, etc.) to be represented on the display.

The formatter 33 arranges each item on a screen of the display 13 based on the layout tree 25 and information concerning a screen size of the display 13. That is to say, the formatter 33 arranges the items on the screen of the display 13 and determines positions, widths, and heights of the items on the screen, and linefeed positions in the html document 21.

The html document 21, which is the requested page, is processed through the parser 31, the page maker 32, the formatter 33 and displayed on the display 13.

The mobile terminal 10 is provided with an in-terminal information managing module 60. The in-terminal information managing module 60 is a program module stored in the ROM 5 to achieve a specific function. The in-terminal information managing module 60 is, similarly to the browser 50, developed in a predetermined area in the RAM 7 to be executed. The in-terminal information managing module behaves in cooperation with the browser 50 to achieve the specific function.

### First Embodiment

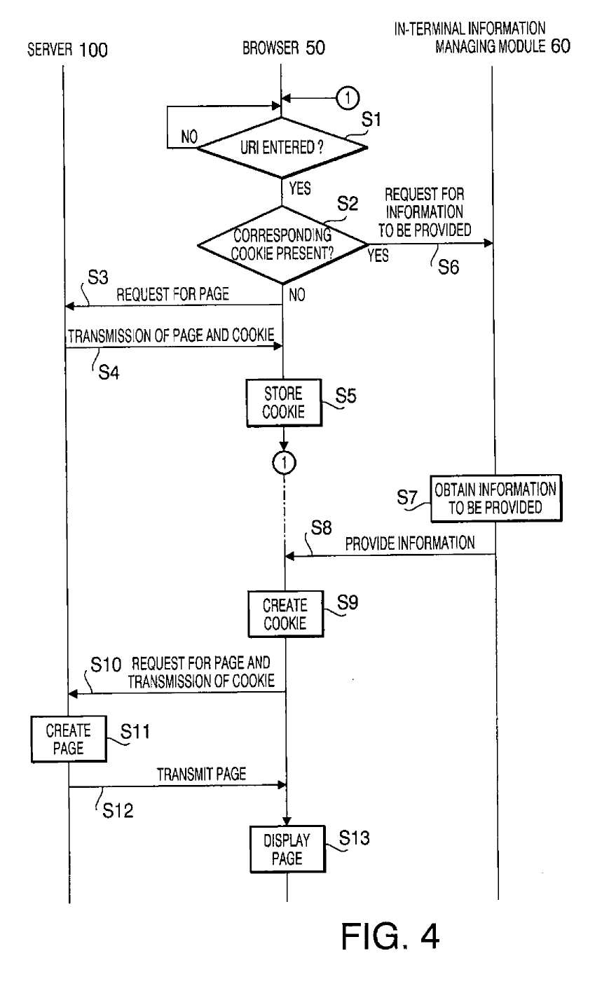

In FIG. 4, a flow to be processed in the network system including the mobile terminal 100 and the server 100 according to a first embodiment of the present invention is illustrated. More specifically, a flow to be processed in the browser 50, the in-terminal information managing module 60, and the server 100 is illustrated.

The server 100 is a web server which is accessible to the browser 50 (i.e., a client). In other words, the browser 50 is capable of accessing a number of other servers on the network as well. In the present embodiment, a web site to deliver, for example, weather reports is provided by the server 100.

The process represented in the flowchart shown in FIG. 4 is initiated upon, for example, a power-on operation to the mobile terminal 10. When the process starts, firstly, the browser 50 waits for a URI to be entered (Step 1. Steps to be referred to hereinafter and in the drawings are abbreviated as “S”). The process represented in the flowchart is terminated, when, for example, an interrupting process occurs in the mobile terminal 10 and when the power supply is shut off.

Next, when a URI (a URI of the server 100 in the present embodiment) is entered by a user operation through the user interface device 17 (hereinafter referred to merely as a “user operation”) (S1: YES), the browser 50 searches, for example, a predetermined local folder in the RAM 7 based on the URI being a search key (S2).

The local folder reserves therein cookies obtained and created during interactions with the servers. The “cookie” refers to a file itself which reserves information concerning the mobile terminal 10 (i.e., the user) to be exchanged between the server and the client (i.e., the browser 50). Exchanges of the cookies between the server and the client enable provision of dynamic information to the client. Essential explanation of the cookies is provided in, for example, a non-patent document (“Perfect achievement of web techniques with illustrations,” Nippon Jitsugyo Publishing Co., Ltd. May, 2001 (Fifth Edition), pages 154-159). In the present embodiment, context information requested by the server is provided from the server to the terminal by using the cookies.

In S2, if it is judged that a cookie from a server corresponding to the entered URI (i.e., the server 100) is not present in the local folder (S2: NO), the browser 50 transmits a request for a page corresponding to the URI to the server 100 through the network interface 9 (S3).

When the server 100 receives the request issued in S3, a response (i.e., the page) according to the request is transmitted to the mobile terminal 10 (S4). In this step, the server 100 transmits the cookie along with the page. If the context information requested by the server 100 is, for example, positional information of the user, a cookie containing the following information is transmitted to the mobile terminal 10. The cookie is referred to as “cookie L” for convenience of explanation.

Cookie L

query=“<query><location><nodata></location></query>”

In the cookie L, the character string “query” specifies a type of the context information reserved in the mobile terminal 10. The character string “location” is a type of the specified context information.

The browser 50 receives the page and the cookie L transmitted from the server 100 through the network interface 9. Next, the browser 50 renders the received page as described above to present on the screen of the display 13. Additionally to say, a weather report of, for example, major cities in the nation is presented on the screen of the display 13. Concurrently with rendering of the page, the browser 50 thereafter stores the received cookie L in the local folder (S5). When the cookie L is stored, the process returns to S1.

When the server 100 is adapted not to use cookies, in S4, solely the page is transmitted to the mobile terminal 10. Thereafter, the page is rendered by the browser 50 to be presented on the screen of the display 13. In this flow, the browser 50 skips S5 to return to S1.

Next, a flow to follow S2 when it is judged that the cookie from a server corresponding to the entered URI (i.e., the server 100) is present in the local folder will be described. In this flow, it is assumed that the browser 50 has been accessed the server 100 previously, and the cookie L received through the access is stored in the local folder.

The browser 50, based on the cookie L, requests the in-terminal information managing module 60 for information corresponding to the cookie L (S6). The in-terminal information managing module 60 receiving the request behaves to obtain the information corresponding to the cookie L (S7). That is to say, the in-terminal information managing module 60 behaves to obtain information of a current position of the mobile terminal 10.

The information of the current position of the mobile terminal 10 can be obtained by the GPS receiver 16. The GPS receiver 16 is a unit having a known configuration and is provided with a function to obtain the information of its current position by utilizing GPS signals issued by a GPS satellite which orbits the earth. The GPS receiver 16, for example, measures in two dimensions to obtain the current positional information of the mobile terminal 10 in two-dimensional coordinates.

The in-terminal information managing module 60, in response to the request from the browser 50 issued in S6, accesses the GPS receiver 16 to obtain the current positional information. The GPS receiver 16 executes operations to capture and trace the GPS signals and position-computing, which is triggered, for example, by access of the in-terminal information managing module 60. The current positional information which is obtained through the operations is passed to the in-terminal information managing module 60.

Optionally, the GPS receiver 16 may be operated repeatedly (e.g., at every minute) once the mobile terminal 10 is powered on until the power is shut down to measure the position of the mobile terminal 10. In such an operation, the GPS receiver 16 provides the latest positional information to the in-terminal information managing module 60 in response to access of the in-terminal information managing module 60.

Still optionally, the result of the positioning (i.e., a position and time of measurement) which is obtained periodically as above may be stored, for example, in the RAM 7. The stored information can be used as the context information to represent the user's history of travel.

The in-terminal information managing module 60 converts the current positional information passed from the GPS receiver 16 into a predetermined markup language (e.g., XML (Extensible Markup Language)). Next, the converted current positional information is passed to the browser 50 (S8). The current positional information converted within the in-terminal information managing module 60 in the present embodiment is referred to as “current positional information L” for convenience of explanation. Bellow is represented the current positional information L.

Current positional information L

<east>135.22</east><north>35.66</north>
The above current positional information L represents that the mobile terminal 10 is at longitude 135 degrees 22′ east and latitude 38 degrees 66′ north.

When the current positional information L is passed from the in-terminal information managing module 60, the browser 50 replaces the character string <nodata> in the cookie L with the current positional information L (S9). Thus, a cookie L′ is created according to the replacement. Bellow is represented the cookie L′.

Cookie L′

query=“<query><location><east>135.22</east><north>35.66</north></location></query>”

Following S9, the browser 50 transmits the cookie L′ along with the request for the page corresponding to the URI to the server 100 through the network interface 9 (S10).

When the request and the cookie L′ transmitted in S10 are received, the server 100 creates a response (i.e., the page) according to the request and the cookie L′ (S11).

More specifically, the server 100 is equipped with a relational database having fields for, for example, “local areas,” “coordinates,” and “weather.” The fields for “local areas” contain, for example, information of names of sectioned areas (e.g., municipal areas) in the nation. The fields for “coordinates” contain vector data which defines the sectioned areas contained in the “local areas” fields. The vector data includes biaxial (i.e., latitude and longitude) coordinate data. The “weather” fields contain data for current weather report (e.g., “fair,” “cloudy, occasionally rainy”) in each “local area” provided by, for example, a meteorological bureau.

In S11, the server 100 searches through the relational database based on a key, which is the current positional information L included in the cookie L′. More specifically, the server 100 searches for a record including the current positional information L in a local area defined by the vector data in one of the “coordinates” field. Thereafter, the server 100 uses the data contained in the “local areas” and “weather” fields of the record obtained in the search and executes a CGI (Common Gateway Interface) program, which is for example installed in the server 100 itself, to create the page. Additionally to say, in S11, a page with text and images to indicate an area, in which the mobile terminal 10 is located, and weather news in the area being arranged therein, is created.

Next, the server 100 transmits the page created in S11 to the mobile terminal 10 (S12). The browser 50 receives the page through the network interface 9, renders the page as above, and presents the page on the screen of the display 13 (S13). Thus, the user can browse the weather news focused on the area corresponding to the current position of the user without an operation to narrow down the desired areas through the interface device 17. This can be particularly advantageous in view of operational efficiency and reduction of communication cost, because the page representing the focused weather report can be directly (without browsing through unnecessary pages).

Next, behaviors of the browser 50 accessing a “music distributor server” in place of the “server 100” and the in-terminal information managing module 60 will be described. The music distributor server provides a site which distributes various music pieces.

A flow from S1 to S6 is performed substantially similarly to the previous example. Bellow is represented a cookie to be transmitted in S4 from the music distributor server to the mobile terminal 10 (hereinafter referred to as “cookie PL” for convenience of explanation).

Cookie PL

query=“<query><playlist><nodata></playlist></query>”

A flow to follow S7 will be described. The in-terminal information managing module 60, in response to the request from the browser 50 issued in S7, behaves to obtain information corresponding to the cookie PL. More specifically, the in-terminal information managing module 60 behaves to obtain play list information. The “play list information” refers to information retained in the audio unit 18. Additionally to say, the play list information is information of a list in which music pieces preferred by the user are itemized.

Hereinafter, the audio unit 18 will be briefly described. The audio unit 18 has a configuration similar to that of a known audio device. The audio unit 18 includes a memory unit to store music data, for example, downloaded from a music distributing site, a demodulation unit to demodulating the stored music data, and a speaker to output the demodulated music data. The audio unit 18 is adapted to have a known configuration; therefore, explanation of that in detail is herein omitted. The music data and the like which is downloaded from the music distributing site can be alternatively stored, for example, in the flash memory 20 in place of the memory unit.

The play list information is stored, for example, in the memory unit (or the flash memory 20) of the audio unit 18. The user can create and edit the play list information by operating, for example, the interface device 17. Alternatively, the play list information may be automatically created and updated based on history of the music data having been played.

The in-terminal information managing module 60, in response to the request from the browser 50 issued in S6, accesses the audio unit 18 to search through the memory unit (or the flash memory 20) to obtain the play list information. Next, the obtained play list is converted into a predetermined markup language. The converted play list information is thereafter passed to the browser 50 (S8). The play list information converted within the in-terminal information managing module 60 is referred to as “play list information PL” in the present embodiment for convenience of explanation.

When the browser 50 receives the play list information PL passed from the in-terminal information managing module 60, the browser 50 replaces the character string <nodata> in the cookie PL with the play list information PL (S9). Thus, a cookie PL′ is created according to the replacement. Bellow is represented the cookie PL′.

Cookie PL’

query=
″<query><playlist>

<track>

<number>001</number>
<title>XYZ</title>
<artist>John </artist>
<album>XXX</album>
<genre>Jazz</genre>

</track>
<track>

<number>002</number>
<title>FFFFF</title>
<artist>Mary</artist>
<album>YYYY</album>
<genre>pop</genre>

</track>

. . .
</playlist></query>″

The play list information PL has a data structure, in which music data for each music piece is separated by a <track> tag. Thus, an application program (e.g., a program in the music distributor server) can recognize the data in each music piece separately. The data in each music piece is configured with “track number,” “track title,” “artist name,” “album title,” and “genre.” The “track number,” the “track title,” the “artist name,” the “album title,” and the “genre” are respectively defined by <number>, <title>, <artist>, <album>, and <genre> tags.

The browser 50, following S9, transmits a request to obtain the page corresponding to the URI and the cookie PL′ to the server 100 through the network interface 9 (S10).

When the music distributor server receives the request and the cookie PL′ passed in S10, the music distributor server creates a response (i.e., the page) according to the request and the cookie PL′ (S11).

More specifically, the music distributor server is equipped with a relational database having fields for, for example, “track title,” “artist name,” “album title,” and “genre.” The fields contain data corresponding to the names of the fields.

In S11, the music distributor server analyses preferences of the user of the mobile terminal 10 based on the play list PL included in the cookie PL′ according to a predetermined algorithm. Thereafter, the relational database is searched through for obtained results of the analysis to extract some records which can be considered to match the user's preferences. The music distributor server thereafter uses data contained in the records and executes a CGI program, which is for example installed in the music distributor server itself, to create the page. Additionally to say, the music distributor server creates a page in which track titles likely to match the user's preferences are listed.

Next, the music distributor server transmits the page created in S11 to the mobile terminal 10 (S12). The browser 50 receives the page through the network interface 9, renders the page as above, and presents the page on the screen of the display 13 (S13). Thus, the user can browse the page in which the track titles likely to match the user's own preferences are listed.

When any of the listed track titles is selected through a user's operation, the browser 50 communicates with the music distributor server and obtains the page with the URI, which is specified by the anchor tags corresponded to the track title. This page is, for example, provided to inquire the user as to whether the user wishes to purchase the music piece selected by the user's operation. The user can enter further operations through the page in order to purchase the music piece and download in the mobile terminal 10. In the example of the above music distributor server, a network system which preferably presents music pieces likely to match the user's preferences is provided by using the cookie. That is to say, the user can browse the list of favorable music pieces solely by using the browser 50 to access the music distributor server.

As has been described above, according to the present embodiment, the server can designate a type of context information requested by the server itself by using the cookie, which is transmitted to the client. That is to say, according to the present embodiment, the type of the context information can be designated by the server. According to the present embodiment, the type of the context information requested by the server can be flexibly changed by the server by changing contents of the cookies.

### Second Embodiment

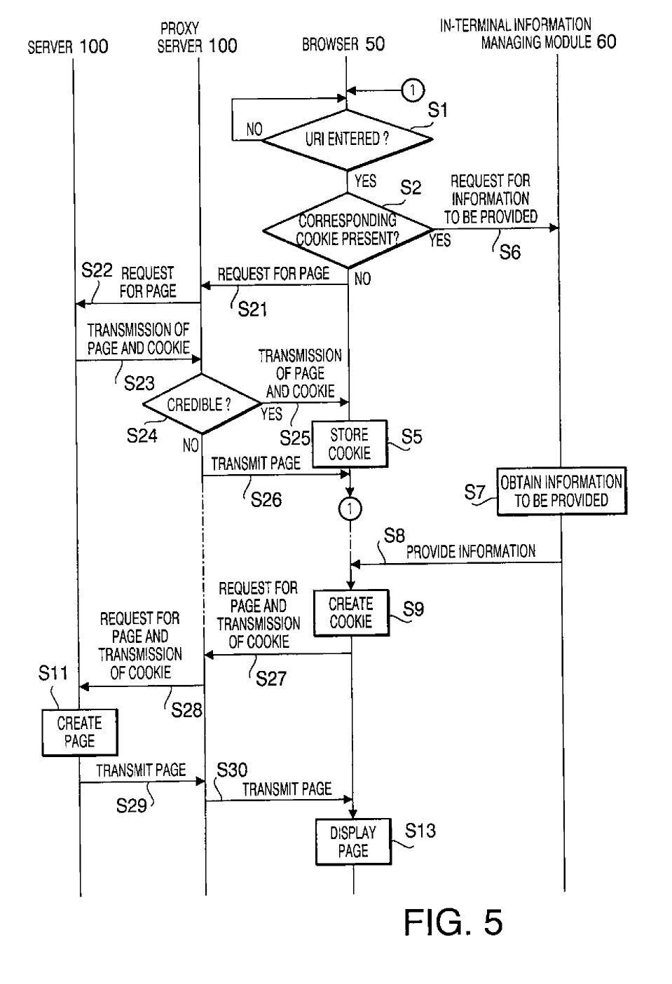

Next, a network system according to a second embodiment of the present invention will be described. In the network system according to the second embodiment, communication between the browser of the mobile terminal and the server requesting the context information is performed via a proxy server. This is due to security reasons. FIG. 5 is a flowchart to illustrate processes to be executed in the network system according to the second embodiment of the present invention. More specifically, FIG. 5 shows a flow of processes to be executed among the browser 50, the in-terminal information managing module 60, a server 110, and a proxy server 200. The server 110 can be, for example, similarly configured server to the music distributor server in the first embodiment. In the following description, a process which is substantially similar to the process in the first embodiment is referred to by an identical reference signs, and detailed description of that will be omitted.

In the second embodiment, the browser 50 executes the processes in S1 and S2. When negative judgment is made in S2, the browser 50 transmits the request for the page corresponding to the URI entered in S1 to the server 110 through the network interface 9 (S21). According to the second embodiment, the browser 50 is configured to transmit all the packets from the mobile terminal 10 to the designated address (i.e., the server 110 in the present embodiment) via the proxy server 200. That is to say, the request is received by the proxy server 200.

The proxy server 200 transmits a request to the server 100 in place of the request from the browser 50 (S22). That is to say, the proxy server 200 requests for the page corresponding to the entered URI on behalf of the browser 50.

The server 110, receiving the request from the proxy server 200, transmits a response (i.e., the page) according to the request to the proxy server 200 (S23). In this regard, the server 110 transmits the cookie in addition to the page.

The proxy server 200, receiving the page and the cookie transmitted from the server 110, judges as to whether the server 110 is a reliable server (S24). The judgment is made based on a database equipped to the proxy server 200. The database stores URIs of unreliable servers. Therefore, if the URI of the server 110 is not included in the database, the server 110 is determined to be a reliable server (S24: YES). Meanwhile, if the URI of the server 110 is included in the database, the server 110 is determined to be an unreliable server (S24: NO).

Alternatively, the database may store URIs of reliable servers. According to this configuration, if the URI of the server 110 is included in the database, the server 100 is determined to be a reliable server (S24: YES). Meanwhile, if the URI of the server 110 is not included in the database, the server 110 is determined to be an unreliable server (S24: NO).

When affirmative judgment is made in S24, the proxy server 200 determines that the server 110 is reliable and permits the page and the cookie from the server 110 to be transmitted to the mobile terminal (S25). Therefore, the browser 50 receives the page and the cookie transmitted from the proxy server 200 through the network interface 9. Thereafter, the browser 50 renders the received page as described above to present on the screen of the display 13. The browser 50 thereafter stores the received cookie in the local folder (S5).

In the above case, following S5, when the browser 50 requests the server 110 for a page, the processes similar to S6 through S9 as described above are performed. Following S9, the browser 50 transmits the request for the page to the server 110 along with the cookie including the context information (S27). The request and the cookie are transmitted to the server 110 by the proxy server 200 on behalf of the browser 50 (S28).

In S11, the server 110 creates the page based on the received request and the cookie and transmits the same to the proxy server 200 (S29). Thereafter, the proxy server 200 transmits the received page to the mobile terminal 10 (S30). The browser 50 receives the page through the network interface 9, renders the page as described above, and presents the page on the screen of the display 13 (S13).

Meanwhile, if negative judgment is made in S24, the proxy server 200 determines that the server 110 is unreliable and permits solely the page from the server 110 to be transmitted to the mobile terminal 10 (S26). That is to say, the proxy server 200 does not permit the cookie to be transmitted. It is to be noted that the cookie is to request the context information (i.e., personal information of the user or information concerning the personal information). The proxy server 200 filters out the cookie in view of protection of personal information. In this regard, following S26, if the browser 50 requests the server 110 for a page, the processes in S1, S2, and S21-26 are performed. Optionally, security levels of the proxy server 200 may be changed so that obtainment of the page as well as the cookie is restricted in S26. The change of the security levels may be achieved by, for example, the browser 50 directly accessing the proxy server 200 to request for the change of the levels. The filtering process performed by the proxy server 200 against an unreliable server can be divided into the following levels based on the security levels.

Security level 1

A page is permitted. Permission of a cookie is selected by the user.

Security level 2

A page is permitted. A cookie is not permitted.

Security level 3

Permission of a page is selected by the user. A cookie is not permitted.

Security level 4

Neither a page nor a cookie is permitted.

As has been described above, according to the second embodiment, the proxy server 200 filters the cookie. According to the second embodiment, a preferable configuration to protect the user's personal information in the network system, in which the context information is used, is provided.

### Third Embodiment

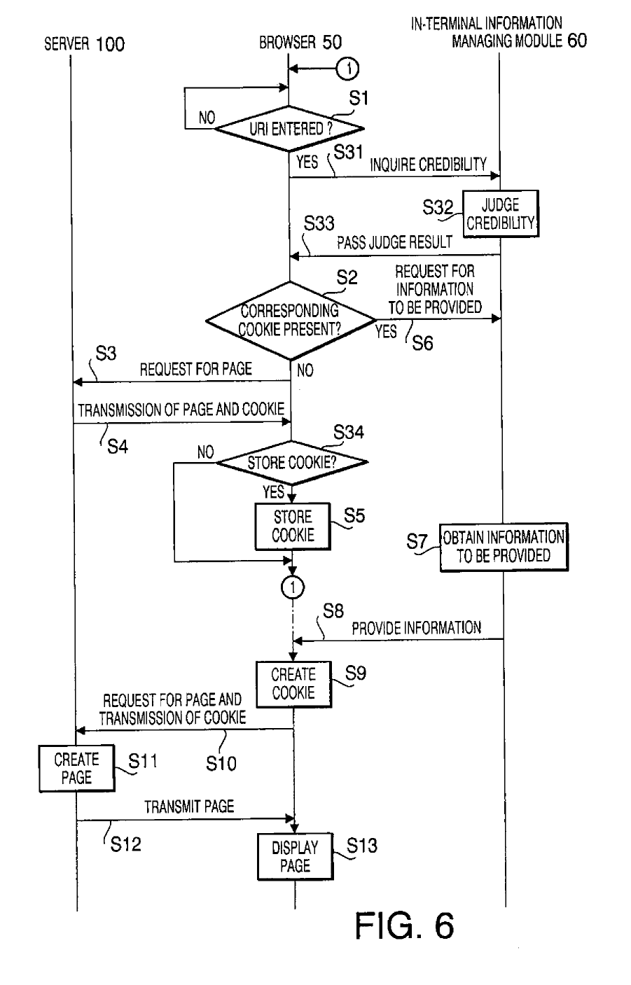

Next, a network system according to a third embodiment of the present invention will be described. FIG. 6 is a flowchart to illustrate processes to be executed in the network system according to the third embodiment of the present invention. More specifically, FIG. 6 shows a flow of processes to be executed among the browser 50, the in-terminal information managing module 60, and a server 120. The server 120 can be, for example, similarly configured server to the music distributor server in the first embodiment.

In the third embodiment, when the URI is entered in S1, the browser 50 inquires with the in-terminal information managing module 60 about the reliability of a server corresponding to the URI (i.e., the server 120 in the present embodiment) (S31). The in-terminal managing module, receiving the inquiry, searches through a database stored in, for example, the RAM 7. Thereafter, it is determined as to whether the server 120 is a reliable server (S32). The database to be used in the present embodiment is assumed to store the identical contents with the database equipped to the proxy server 200 in the second embodiment.

Thereafter, when negative judgment is made in S2, the browser transmits a request for a page corresponding to the URI entered in S1 to the server 120 through the network interface 9 (S3). The server 120 transmits the page and the cookie in response to the request (S4). If affirmative judgment is made in S2, the processes in S6 through S13 as described above are performed.

The browser 50 judges as to whether the cookie from the server 120 to be saved based on the judgment passed in S33 (S34). If the server 120 is determined to be reliable according to the judgment (S34: YES), the browser 50 saves the cookie from the server 120 in the local folder (S5) and returns to S1. Meanwhile, if the server 120 is determined to be unreliable according to the judgment (S34: NO), the browser 50 returns to S1 without saving the cookie from the server 120 in the local folder.

Thus, according to the third embodiment, a preferable configuration to protect the user's personal information in the network system, in which the context information is used, is provided as well. Additionally, in the third embodiment, the filtering process against the cookie is executed by the in-terminal information managing module 60. That is to say, according to the third embodiment, installation of a proxy server in the network system is not necessary.

### Fourth Embodiment

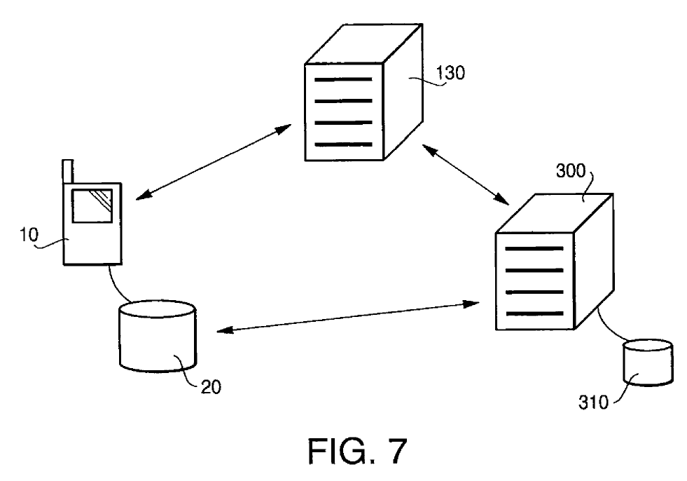

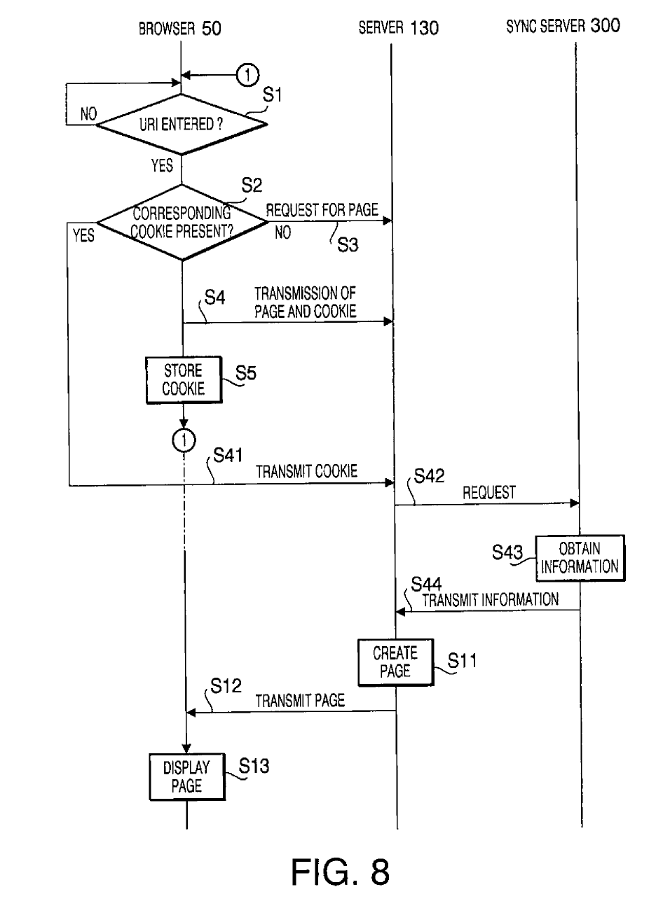

Next, a network system according to a fourth embodiment of the present invention will be described. FIG. 7 is a diagram to schematically illustrate a configuration of the network system according to the fourth embodiment of the present invention. As shown in FIG. 7, the network system in the fourth embodiment includes the mobile terminal 10, a server 130, and a Sync server 300. FIG. 8 is a flowchart to illustrate processes to be executed in the network system according to the fourth embodiment of the present invention. More specifically, FIG. 8 shows a flow of processes to be executed among the browser 50 (the mobile terminal 10), the server 130, and the Sync server 300.

In the fourth embodiment, a Sync ML client software program and a Sync ML server software program are installed respectively in the mobile terminal 10 and the Sync server 300. When a data synchronizing process is executed by the programs in accordance with a Sync ML standard procedure, the flash memory 20 in the mobile terminal 10 and a database 310 in the Sync server 300 are synchronized. The server 130 can be, for example, similarly configured server to the music distributor server in the first embodiment. Meanwhile, configuration of the Sync server 300 is not limited as long as a function to synchronize the data with the contents of the flash memory 20 is provided thereto. The Sync server 300 may be, for example, a server installed in a house of the user of the mobile terminal 10 or may be provided by a network provider to the user. In the latter case, for example, an area of an HDD in the Sync server 300 is assigned to the user, and the area is synchronized with the data in the flash memory 20.

The processes in S1 through S5 are performed substantially similarly to those in the first embodiment. In the present embodiment, a cookie is set in the browser 50 by the server 130 to access the area, which is synchronized with the flash memory 20. Further, in S2, if the cookie corresponding to the server 130 is stored in the local folder (S2: YES), the browser 50, according to the cookie, includes a URI indicating the area to be synchronized with the flash memory 20 in the cookie and returns the cookie to the server 130 (S41).

The server 130, receiving the cookie from the browser 50, accesses the Sync server 300 according to the URI included in the cookie to request play list information (S42). The Sync server 300 receiving the request searches for the area to be synchronized with the flash memory 20, obtains the play list information (S43), and transmits the same to the server 130 (S44).

The server 130 receiving the play list information from the Sync server 300 uses the play list information to create a page (S11) and transmits the same to the browser 50 (S12). Thus, the page, in which track titles likely to match the user's preferences are listed, is presented on the display 13 of the mobile terminal 10 (S13).

According to the fourth embodiment, the process to search for the play list is executed in the Sync server 300. A search processing speed of the Sync server 300 is exceptionally faster than a search processing speed of the mobile terminal, which is limited in resources. Therefore, a processing speed of the entire system may be improved according to circumstances. (Namely, a processing time from S2 to S13 can be shortened.) In this regard, it can be expected that the page in which the track titles likely to match the user's preferences are listed can be displayed in the browser 50 more speedily.

Optionally, the user can set the browser 50 not to provide the URL of the Sync server 300 to the server 130. In this case, similarly to the first embodiment, the flash memory 20 is searched through in order to obtain the play list information.

Above has been described the examples of the present invention. However, embodiments of the present are not limited to the above-described examples, but may be achieved in numerous variations within the scope of the invention. For example, the present invention can be applied not only to the mobile terminal but also to a non-mobile terminal such as a desktop PC. Further, an embodiment of the present invention can be achieved by suitably combining any of the above-described first through fourth embodiments and variations which will be described below.

According to the present invention,

For example, types of the context information used in the embodiments are not necessarily limited to the current positional information or the play list information. The other possible types of the context information may be, for example, information concerning history of operations made by the user in the mobile terminal 10. More specifically, the information concerning history of operations may include history concerning web browsing (e.g., entered URI, entry time of the URI, positional information at the time of the entry), history concerning music pieces having been played by the audio unit 18 (e.g., track names of the music pieces having been played, artists concerning the music pieces, genre, played times, positional information at the time of play), and history concerning various application programs installed in the mobile terminal 10 (e.g., types of the programs, used times, positional information at the time of use). When the mobile terminal 10 is equipped with a known mailer program, the types of the context information may include, for example, a number of mails having been exchanged, times of mail transmission/reception, positional information at the time of mail transmission/reception. When the mobile terminal 10 is equipped with an IC card function such as SUICA®, for example, the types of the context information may include a type of affiliated services in which the IC card function is used, times of use, positional information at the time of use.

Further, the in-terminal information managing module 60 in the above embodiments is a single and independent application program installed in the mobile terminal 10. However, the in-terminal information managing module 60 may be installed in, for example, each application program such as a mailer or in each function in the mobile terminal 10.

Furthermore, for example according to the second embodiment, a network system, in which the proxy server 200 automatically charges another server (e.g., the server 110) for the context information being provided, may be provided. In such an automatic charging network system, it is required that the server requesting for the context information is subscribed to the automatic charging service provided by the proxy server 200. The subscription may be made online or in writing. The proxy server 200 has a first database, which stores information concerning the subscribed servers (e.g., URIs of the servers, names of administrators of the servers, addresses and bank accounts of the administrators, and e-mail addresses). The proxy server 200 accepts subscription by only servers which are judged to be reliable.

On the other hand, the users are required to subscribe the proxy server 200 in order to achieve the dynamic information which reflects the context information. The subscription also may be made online or in writing. The proxy server 200 has a second database, which stores information concerning the subscribed users (e.g., user names and addresses of terminals which belong to the users). When the users are subscribed to the proxy server 200, the browser 50 is configured such that the entire packets from the mobile terminal 100 are transmitted to a designated destination (i.e., the server 100 in the above embodiments) via the proxy server 200. That is to say, the proxy server 200 serves only for the subscribed clients.

Hereinafter, processes to be executed in the automatic charging network system will be described with reference to FIG. 5. The processes are initiated when the user (i.e., the mobile terminal 10) and the server 110 are subscribed to the proxy server 200 and upon entry of the URI of the server 110 in the browser 50.

When the browser 50 initially accesses the server 100 in the automatic charging network system, processes in S1, S2, and S21-23 are executed in sequence. When the proxy server 200 receives a request from the browser 50 transmitted in S21, the proxy server 200 searches through the second database. As a result of the search, when the request is issued by a subscribed user, the proxy server 200 serves as an agent server of the user. That is to say, a process in S22 is executed.

Next, the proxy server 200 judges, in place of the above-described reliability judging process, as to whether the server 110 is a subscribed server. The process to judge the subscription is made by using the first database. When the server 110 is determined to be a subscribed server, the proxy server 200 permits a page and a cookie from the server 110 to transmit to the mobile terminal 10 (S25). Meanwhile, when the server 110 is determined not to be a subscribed server, the proxy server 200 permits solely the page to transmit to the mobile terminal 10 (S26). In this regard, similarly to the second embodiment, a security level may be set in the proxy server 200.

In the automatic charging network system, if the browser 50 has accessed the server 110 prior to the current access, processes in S1, S2, S6-p, S27-30, and S13 are executed in sequence. The proxy server 200 charges the server 100 upon transmission of the cookie including the context information in S28. In addition, if a third party who suggests the automatic charging network system is present, the proxy server 200 charges the server 100 for an amount including margin to be paid to the third party.

In the charging process, the proxy server 200, for example, searches through the first database to obtain information of a bank account for an administrator of the server 110. Thereafter, a process to withdraw a predetermined amount for a consideration of the context information being provided from the bank account is executed online. Further, the proxy server 200 searches through the first database to obtain a name, an address, and an e-mail address of the administrator of the server 110, and transmits a bill statement to the administrator via a postal mail or an e-mail. Alternatively, communication history with the server 100 is stored in the first database so that a bill statement made according to the stored data can be transmitted to the server 110 after a predetermined time period (e.g., monthly) online or via a postal mail.

Alternatively, the proxy server 200 may execute the charging process to charge the server 110 upon transmission of the page which reflects the context information to the mobile terminal in S30.

The automatic charging network system can be respectively advantageous to the user, the server 110, and the proxy server 200. The user can be benefited by, for example, the dynamic service which reflects the user's requirement. The server can be benefited by, for example, presenting the music pieces to meet the user's requirement to merchandise effectively. The proxy server 200 can be benefited by collecting the fees for the provided context information from the servers.

In a different embodiment, the context information to be obtained from the in-terminal information managing module 60 may be transmitted in a data format which is different from the cookie. The format different from the cookie may be, for example, POST and GET. In the embodiment, the context information obtained from the in-terminal information managing module 60 is converted in a predetermined conversion process in the browser 50 to be transmitted as a POST (or GET) request in HTTP. Thereafter, in the server, the database is searched through based on the POST (or GET) request, and a page is created by CGI to be transmitted. The POST request and the GET request can be more advantageous due to capability to transmit a larger amount of data.

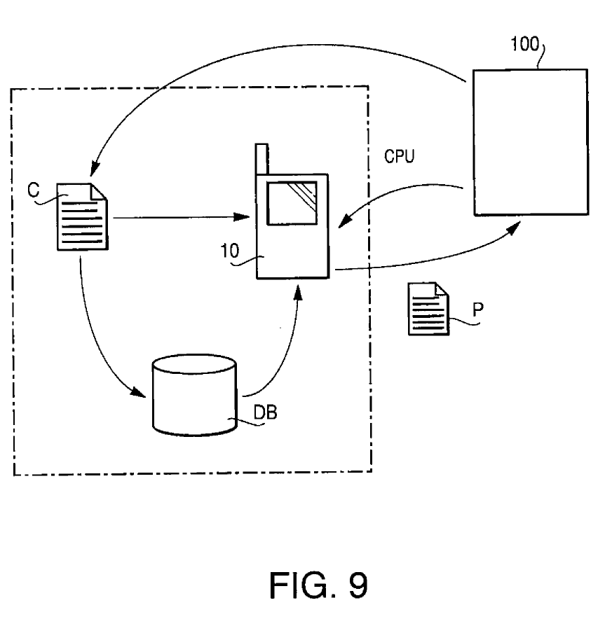

An example of POST will be described with reference to FIG. 9. The network system is, for example, configured with the mobile terminal and the server 100, similarly to the above embodiments. As shown in FIG. 9, the mobile terminal 10 receives and saves the cookie transmitted from the server 100, and searches through a DB (e.g., the flash memory 20) in the mobile terminal 10 according to contents of the cookie C (i.e., a request from the server 100). Thereafter, the mobile terminal 10 converts the information obtained by the search to create a POST request P and returns the created POST request P to the server 100. The server 100 dynamically creates a page according to the information included in the POST request P and provides the created page to the mobile terminal 10.

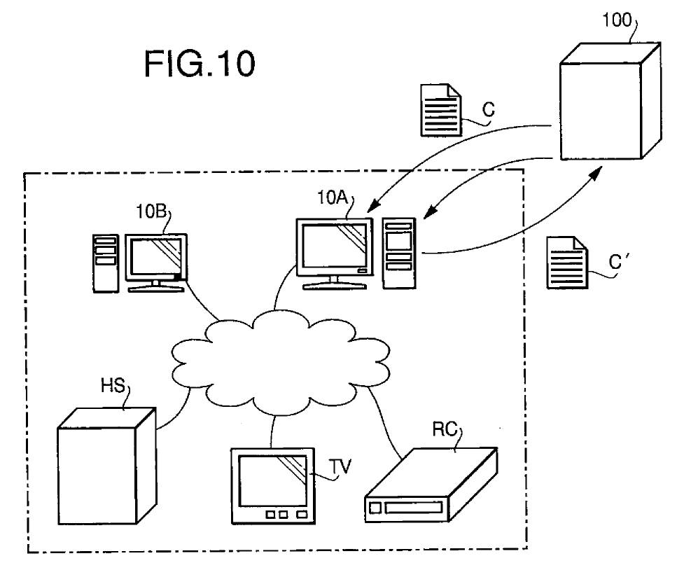

In the embodiments, the context information of a single mobile terminal 10 is obtained to be returned to the server according to the request in the cookie. However, in a different embodiment, for example, context information concerning a plurality of mobile terminals may be collected to be returned to the server. An example will be described with reference to FIG. 10. In the example, an environment in which the context information is provided is assumed to be an in-home network (domestic LAN) having a plurality of terminal devices (e.g., desktop PCs 10A, 10B, an in-house server HS, a television TV, an HDD recorder RC) which are connected through, for example, a network which is standardized by DLNA (Digital Living Network Alliance). When one of the terminal devices (the desktop PC 10A in the present example) with a cookie being set accesses the server, the desktop PC 10A behaves as a DMC (Digital Media Controller) according to the cookie to access the other terminal devices in the in-home network and issues an instruction to the terminal devices to obtain the context information. The terminal devices receiving the instruction, i.e., the desktop PC 10B, the in-home server HS, the television TV, the HDD recorder RC behave as DMSs (Digital Media Servers), search through their own memory media to obtain the context information, and transmit the obtained context information to the desktop PC 10A which behaves as the DMC. Thus, the terminal device behaving as the DMC collects the context information, e.g., a list of audiovisual pieces and a play list, to incorporate the same in the cookie and return the same to the server. When a terminal device with a cookie being set is the desktop PC 10B, the desktop PC 10B behaves as the DMC, and the desktop PC 10A, the in-home server HS, the television TV, and the HDD recorder RC behave as the DMSs. According to the present embodiment, the context information sporadic in a plurality of terminal devices can be easily collected and returned to the server. When a terminal device with a cookie being set is a mobile terminal such as a cell phone, the terminal device behaves as an MDMC (Mobile Digital Media Controller) according to the cookie, accesses the other terminal devices in the in-home network, and issues an instruction to the terminal devices to obtain the context information.

Optionally, a Sync ML-enabled in-home server, of which data can be synchronized with the data within the entire in-home network, may be provided in the in-home network. In this configuration, a terminal device behaving as the DMC can access the in-home server to obtain the context information of the entire terminal devices within the in-home network.

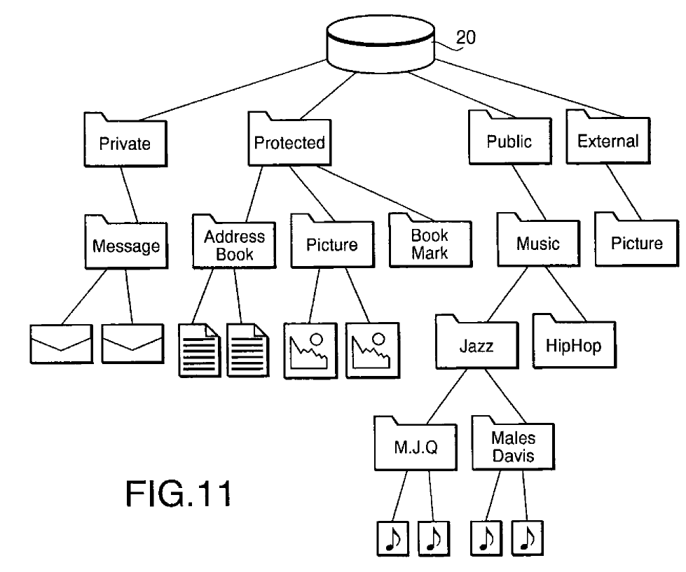

Further according to another embodiment, the server can designate the context information to request for to the mobile terminal 10 more specifically. FIG. 11 hierarchically illustrates data stored in the flash memory 20 of the mobile terminal 10. As shown in FIG. 11, for example, mails exchanged by a mailer in the mobile terminal 10 are stored in a “message” folder which belongs to a “Private” folder in the flash memory 20. Further, for example, addresses registered in an address book are stored in an “AddressBook” folder which belongs to a “Protected” folder.

In the above embodiment, the hierarchical structure of the flash memory 20 is assumed to be known to the server. Therefore, the server can request to the browser 50 for the data in a desired folder by using the cookie. For example, the server can set the following cookie C to the browser 50.

Cookie C

query=“<query><public/music/jazz/milesdavis/><nodata></public/music/jazz/milesdavis/></query>”
According to the cookie C, data “public/music/jazz/milesdavis/,” which is the data (MP3 data in the present example) in a “MilesDavis” folder being in a tier being lower for three tiers from a “Public” folder is designated. Thereafter, when the browser 50 and the in-terminal information managing module 60 operate in cooperation with each other, metadata (i.e., information similar to the play list information PL) of the MP3 data in the “MilesDavis” folder, for example, is obtained. Next, the obtained metadata is incorporated in the cookie C and returned to the server, the server searches through the database, creates a page by the CGI, and transmits the page. Thus, the user can browse the page associated with, for example, MilesDavis.

Optionally, permissibility of providing the context information may be set on a folder basis within the mobile terminal 10 in view of privacy of the user. For example, when the “Private” and the “Protected” folders are set to be impermissible to provide the context information, even if the “Private” and the “Protected” folders are designated by the cookie, the data in the folders is not incorporated in the cookie within the mobile terminal 10 or transmitted to the server. In this situation, a normal page (i.e., a page corresponding to the URI entered in S1 and not created by the CGI) is displayed by the browser 50. Further, for example, when a “HipHop” folder is set to be impermissible to provide the cookie, and when a “Music” folder is designated in the cookie, the context information in folders in the “Music” folder other than the “HipHop” folder is collected to be incorporated in the cookie and transmitted to the server.

Optionally, permissibility of providing the context information may be set on a server basis within the mobile terminal 10. For example, the context information in the “Private” and the “Protected” folders may be set to be impermissible to be provided to a server A, while the context information in the “Private,” “Protected” and “External” folders may be set to be impermissible to be provided to a server B. Thus, because permissibility of providing can be set on a server basis, adequate context information can be provided to a qualified server while privacy of the user is protected.

Optionally, according to an embodiment of the present invention, an input system to accept input from a user and cookie reception judging system to judge as to whether the cookie receiving system has received the cookie when the input system accepts input of an address of the external server may be provided. When the cookie reception judging system judges that the cookie receiving system has received the cookie, the context information extracting system may extract the specific context information from the predetermined memory medium based on the cookie.

Optionally, according to an embodiment of the present invention, the context information storing system may store information concerning history of input being received by the input system.

Optionally, according to an embodiment of the present invention, the terminal may further include a language converting system to convert the specific context information into a language in a format identical to a format of the cookie and a cookie incorporating system to incorporate the converted context information to the cookie. In this configuration, the transmitting system transmits the cookie with the context information incorporated to the external server.

Optionally, according to an embodiment of the present invention, the terminal may further include a request generating system to apply a predetermined converting process to the specific context information to generate a POST request or a GET request. The transmitting system may transmit the generated POST request or the GET request to the external server.

Optionally, according to an embodiment of the present invention, the terminal may include a credibility judging system to judge credibility of the external server. In this configuration, the cookie receiving system may receive the cookie only from the external server which is judged to be credible.

Optionally, according to an embodiment of the present invention, the context information storing system may manage the context information in hierarchy and administer context information which permits or prohibits extraction by the context information extracting system on a tier basis. Additionally, the context information, of which extraction is permitted or prohibited by the context information extracting system may be administered on basis of an external server to which the context information is provided.

Optionally, according to an embodiment of the present invention, the terminal may further include a positional information obtaining system to obtain current positional information of the terminal itself. In this configuration, the context information obtaining system may operate the positional information obtaining system to obtain the current positional information.

Optionally, according to an embodiment of the present invention, the predetermined protocol is, for example, Sync ML.

Optionally, according to an embodiment of the present invention, the network system may further include a relay server which is positioned between the external server and the terminal within the predetermined network and relays communication between the external server and the terminal.

Optionally, according to an embodiment of the present invention, the relay server may include a criterion judging system to judge as to whether the external server meets a predetermined criterion, and a filtering system to apply a filtering process to data passed from the external server being judged, based on the judgment.

Optionally, according to an embodiment of the present invention, the predetermined criterion refers to, for example, credibility of the external server.

Optionally, in the network system according to an embodiment of the present invention, a level of the filtering process applied by the filtering system may be changeable.

Optionally, according to an embodiment of the present invention, the relay server may include an accounting system to charge the external server for transmission of the specific context information which is relayed by the terminal.

Optionally, according to an embodiment of the present invention, the terminals within the LAN may be capable of communicating with one another through a network which is standardized by DLNA (Digital Living Network Alliance), and the terminal receiving the cookie from the external server may behave as a controller, and the other terminals may behave as servers.

Optionally, according to an embodiment of the present invention, the method to provide context information may include an input step, in which input by a user to the terminal is accepted, and a cookie reception judging step, in which judgment, as to whether the cookie from the external server has been received when input of an address of the external server is accepted in the input step, is made. The specific context information is, for example, extracted in the context information extracting step based on the cookie when it is judged that the cookie has been received.

Optionally, according to an embodiment of the present invention, the method to provide context information may include a context information storing step, in which the terminal stores the context information.

Optionally, according to an embodiment of the present invention, the method to provide context information may further include a language conversion step, in which the terminal converts the specific context information into a language in an identical format with a format of the cookie, and a cookie incorporation step, in which the converted context information is incorporated in the cookie. In this configuration the cookie with the incorporated context information is transmitted to the external server in, for example, the first transmission step.

Optionally, according to an embodiment of the present invention, the method to provide context information may further include a request generating step, in which the terminal applies a predetermined converting process to the specific context information to generate a POST request or a GET request. The generated POST request or the GET request may be transmitted to the external server in the first transmission step.

Optionally, according to an embodiment of the present invention, the method to provide context information may further include a page creation step, in which the external server creates a page based on the received context information, and a second transmission step, in which the created page is transmitted to the terminal.

Optionally, according to an embodiment of the present invention, in the method to provide context information, the communication between the terminal and the external server in each transmission step may be relayed by a relay server.

Optionally, according to an embodiment of the present invention, the method to provide context information may further include a criterion judging step, in which the relay server judges as to whether the external server meets a predetermined criterion, and a filtering step, in which a filtering process is applied to data passed from the external server being judged based on the judgment.

Optionally, according to an embodiment of the present invention, the predetermined criterion refers to, for example, credibility of the external server.

Optionally, in the filtering step according to an embodiment of the present invention, a level of the filtering process applied by the filtering system may be changeable.

Optionally, according to an embodiment of the present invention, the method to provide context information may further include an accounting step, wherein the relay server charges the external server for transmission of the specific context information which is relayed by the terminal.

1. A terminal which is capable of communicating with an external server, comprising:
a context information storing system to store context information in a predetermined memory medium;
a cookie receiving system to receive a cookie, which is to request for specific context information, during communication with the external server;
a context information extracting system to extract the specific context information from the predetermined memory medium according to the received cookie; and
a transmitting system to transmit the extracted context information to the external server.

2. The terminal according to claim 1, further comprising:
an input system to accept input from a user; and
a cookie reception judging system to judge as to whether the cookie receiving system has received the cookie when the input system accepts input of an address of the external server,
wherein the context information extracting system extracts the specific context information from the predetermined memory medium based on the cookie when the cookie reception judging system judges that the cookie receiving system has received the cookie.

3. The terminal according to claim 2, wherein the context information storing system stores information concerning history of input being received by the input system.

4. The terminal according to claim 1, further comprising:
a language converting system to convert the specific context information into a language in a format identical to a format of the cookie; and
a cookie incorporating system to incorporate the converted context information to the cookie,
wherein the transmitting system transmits the cookie with the context information incorporated to the external server.

5. The terminal according to claim 1, further comprising:
a request generating system to apply a predetermined converting process to the specific context information to generate one of a POST request and a GET request,
wherein the transmitting system transmits one of the generated POST request and the GET request to the external server.

6. The terminal according to claim 1, further comprising:
a credibility judging system to judge credibility of the external server,
wherein the cookie receiving system receives the cookie only from the external server which is judged to be credible.

7. The terminal according to claim 1,
wherein the context information storing system manages the context information in hierarchy and administers context information which permits extraction by the context information extracting system on a tier basis.

8. The terminal according to claim 1,
wherein the context information storing system manages the context information in hierarchy and administers context information which prohibits extraction by the context information extracting system on a tier basis.

9. A terminal, having at least one application capable of generating information which is to be context information, and capable of communicating with an external server, comprising:
a cookie receiving system to receive a cookie, which is to request for specific context information, during communication with the external server;
a context information obtaining system to operate the at least one application based on the received cookie and obtain context information being generated as a result of the operation; and
a transmitting system to transmit the obtained context information to the external server.

10. The terminal according to claim 9, further comprising:
a positional information obtaining system to obtain current positional information of the terminal itself,
wherein the context information obtaining system operates the positional information obtaining system to obtain the current positional information.

11. A terminal capable of communicating with an external server, comprising:
a context information storing system to store context information in a predetermined memory medium;
a data synchronization system to synchronize data in the predetermined memory medium and data in an external memory medium which is installed externally to the terminal by using a predetermined protocol;
a cookie receiving system to receive a cookie to request for an address of the external memory medium during communication with the external server; and
a transmitting system to transmit the address of the external memory medium to the external server based on the received cookie.

12. The terminal according to claim 11, wherein the predetermined protocol is Sync ML.

13. A network system comprising at least one terminal which is capable of communicating with at least one external server which is capable of communicating with the terminal through a predetermined network,
wherein the terminal includes:
a context information storing system to store context information in a predetermined memory medium;
a cookie receiving system to receive a cookie, which is to request for specific context information, during communication with the external server;
a context information extracting system to extract the specific context information from the predetermined memory medium according to the received cookie; and
a transmitting system to transmit the extracted context information to the external server, and
wherein the external server includes:
a cookie transfer system to pass the cookie to request for specific context information to the terminal which communicates with the external server itself;
a page creating system to create a page based on the specific context information when the server receives the specific context information from the terminal which was operated in response to the cookie; and
a page transmitting system to transmit the created page to the terminal.

14. A network system comprising at least one terminal capable of communicating with at least one external server which is capable of communicating with the terminal through a network, and a synchronization server having an external memory medium of which data is synchronized with data in the predetermined memory medium of the terminal,
wherein the terminal includes:
a context information storing system to store context information in a predetermined memory medium;
a data synchronization system to synchronize data in the predetermined memory medium and data in an external memory medium which is installed externally to the terminal by using a predetermined protocol;
a cookie receiving system to receive a cookie to request for an address of the external memory medium during communication with the external server; and
a transmitting system to transmit the address of the external memory medium to the external server based on the received cookie,
wherein the external server includes:
a cookie transfer system to pass the cookie to request for specific context information to the terminal which communicates with the external server itself; and
a context information requesting system to request the synchronization server for specific context information which is included in the external memory medium when the server receives an address of the external memory medium from the terminal which was operated in response to the cookie,
wherein the synchronization server obtains the specific context information from the external memory medium according to the request when the request from the external server is received to transmit to the external server; and
wherein the external server further includes:
a page creating system to create a page based on the specific context information when the server receives the specific context information from the synchronization server; and
a page transmitting system to transmit the created page to the terminal.

15. The network system according to claim 14, further comprising a relay server which is positioned between the external server and the terminal within the network and relays communication between the external server and the terminal.

16. The network system according to claim 15,
wherein the relay server includes:
a criterion judging system to judge as to whether the external server meets a predetermined criterion; and
a filtering system to apply a filtering process to data passed from the external server being judged, based on the judgment.

17. The network system according to claim 16, wherein the predetermined criteria refers to credibility of the external server.

18. The network system according to claim 16, wherein a level of the filtering process applied by the filtering system is changeable.

19. The network system according to claim 15,
wherein the relay server includes an accounting system to charge the external server for transmission of the specific context information which is relayed by the terminal.

20. A Network system comprising a plurality of terminals being interconnected within a predetermined LAN, at least one of the terminals being capable of communicating with an external server through the Internet;
wherein the at least one of the terminals includes:
a cookie receiving system to receive a cookie to request for specific context information during communication with the external server; and
an instruction system to instruct the other terminals connected through the LAN based on the received cookie to pass the context information,
wherein each of the other terminals includes:
a context information extracting system to extract the specific context information according to the instruction from the instruction system; and
a transmitting system to transmit the extracted context information to the terminal being an issuer of the instruction,
wherein the at least one terminal receives to collect the context information transmitted from the other terminals and transmit the collected context information to the external server.

21. The network system according to claim 20,
wherein the terminals within the LAN are capable of communicating with one another through a network which is standardized by DLNA (Digital Living Network Alliance);
wherein the terminal receiving the cookie from the external server behaves as a controller, and the other terminals behave as servers.

22. A method to provide context information contained in a terminal to an external server through a network, comprising:
a cookie receiving step, in which the terminal receives a cookie to request for specific context information transmitted from the external server;
a context information extracting step, in which the specific context information is extracted by the terminal based on the cookie; and
a first transmission step, in which the extracted context information is transmitted to the external server.

23. The method to provide context information according to claim 22, further comprising:
an input step, in which input by a user to the terminal is accepted; and
a cookie reception judging step, in which judgment, as to whether the cookie from the external server has been received when input of an address of the external server is accepted in the input step, is made;
wherein the specific context information is extracted in the context information extracting step based on the cookie when it is judged that the cookie has been received.

24. The method to provide context information according to claim 22, further comprising a context information storing step, in which the terminal stores the context information.

25. The method to provide context information according to claim 22, further comprising:
a language conversion step, in which the terminal converts the specific context information into a language in an identical format with a format of the cookie; and
a cookie incorporation step, in which the converted context information is incorporated in the cookie,
wherein the cookie with the incorporated context information is transmitted to the external server in the first transmission step.

26. The method to provide context information according to claim 22, further comprising:
a request generating step, in which the terminal applies a predetermined converting process to the specific context information to generate one of a POST request and a GET request,
wherein one of the generated POST request and the GET request is transmitted to the external server in the first transmission step.

27. The method to provide context information according to claim 22, further comprising:
a page creation step, in which the external server creates a page based on the received context information; and
a second transmission step, in which the created page is transmitted to the terminal.

28. The method to provide context information according to claim 22, wherein the communication between the terminal and the external server in each transmission step is relayed by a relay server.

29. The method to provide context information according to claim 28, further comprising:
a criterion judging step, in which the relay server judges as to whether the external server meets a predetermined criterion; and
a filtering step, in which a filtering process is applied to data passed from the external server being judged based on the judgment.

30. The method to provide context information according to claim 29, wherein the predetermined criterion refers to credibility of the external server.

31. The method to provide context information according to claim 29, wherein a level of the filtering process applied in the filtering step is changeable.

32. The method to provide context information according to claim 28, further comprising an accounting step, wherein the relay server charges the external server for transmission of the specific context information which is relayed by the terminal.

33. (canceled)

34. The terminal according to claim 1,
wherein the context information storing system manages the context information in hierarchy and administers context information which permit extraction by the context information extracting system on basis of an external server to which the context information is provided.

35. The terminal according to claim 1,
wherein the context information storing system manages the context information in hierarchy and administers context information which prohibits extraction by the context information extracting system on basis of an external server to which the context information is provided.

36. The network system according to claim 13, further comprising a relay server which is positioned between the external server and the terminal within the predetermined network and relays communication between the external server and the terminal.

37. The network system according to claim 36,
wherein the relay server includes:
a criterion judging system to judge as to whether the external server meets a predetermined criterion; and
a filtering system to apply a filtering process to data passed from the external server being judged, based on the judgment.

38. The network system according to claim 37, wherein the predetermined criteria refers to credibility of the external server.

39. The network system according to claim 37, wherein a level of the filtering process applied by the filtering system is changeable.

40. The network system according to claim 36,
wherein the relay server includes an accounting system to charge the external server for transmission of the specific context information which is relayed by the terminal.

41. A network system comprising at least one terminal, having at least one application capable of generating information which is to be context information and capable of communicating with an external server, comprising:
a cookie receiving system to receive a cookie, which is to request for specific context information, during communication with the external server;
a context information obtaining system to operate the at least one application based on the received cookie and obtain context information being generated as a result of the operation; and
a transmitting system to transmit the obtained context information to the external server. and at least one external server which is capable of communicating with the terminal through a predetermined network,
wherein the external server includes:
a cookie transfer system to pass the cookie to request for specific context information to the terminal which communicates with the external server itself;
a page creating system to create a page based on the specific context information when the server receives the specific context information from the terminal which was operated in response to the cookie; and
a page transmitting system to transmit the created page to the terminal.

42. A network system comprising at least one terminal capable of communicating with an external server and at least one external server which is capable of communicating with the terminal through a network,
wherein the terminal includes:
a context information storing system to store context information in a predetermined memory medium;
a data synchronization system to synchronize data in the predetermined memory medium and data in an external memory medium which is installed externally to the terminal by using a predetermined protocol;
a cookie receiving system to receive a cookie to request for an address of the external memory medium during communication with the external server; and
a transmitting system to transmit the address of the external memory medium to the external server based on the received cookie.
wherein the external server includes:
a cookie transfer system to pass the cookie to request for specific context information to the terminal which communicates with the external server itself;
a page creating system to create a page based on the specific context information when the server receives the specific context information from the terminal which was operated in response to the cookie; and
a page transmitting system to transmit the created page to the terminal.

43. The network system according to claim 42, further comprising a relay server which is positioned between the external server and the terminal within the network and relays communication between the external server and the terminal.

44. The network system according to claim 43,
wherein the relay server includes:
a criterion judging system to judge as to whether the external server meets a predetermined criterion; and
a filtering system to apply a filtering process to data passed from the external server being judged, based on the judgment.

45. The network system according to claim 44, wherein the predetermined criteria refers to credibility of the external server.

46. The network system according to claim 44, wherein a level of the filtering process applied by the filtering system is changeable.

47. The network system according to claim 43,
wherein the relay server includes an accounting system to charge the external server for transmission of the specific context information which is relayed by the terminal.
